(19) United States
(12) Patent Application Publication
(10) Pub. No.: US 2005/0058804 A1
(43) Pub. Date: Mar. 17, 2005

(54) Extruded plastic blade equipped with clips to grab notice papers

(76) Inventor: Pablo Navarro Figueroa, Cidra, PR (US)

Correspondence Address: Eugenio J. Torres, Ferramar Building, Suite 1, 1060 Ashford Avenue, San Juan, PR, 00907, US

(21) Appl. No.: 10/794,890

(22) Filed: Nov. 26, 2004

Related U.S. Application Data
(60) Provisional application No. 60/452,814, filed on Mar. 10, 2003.

(51) Int. Cl. B32B 3/06

(52) U.S. Cl. 428/99

(57) ABSTRACT

A note holder for holding note papers, business cards, etc. The note holder has clips, a channel groove, and a blade. The clips hold the paper by pressing it against the blade. The channel groove allows for the adjustment of the note holder.

### STATEMENT REGARDING FEDERALLY SPONSORED RESEARCH AND DEVELOPMENT

N/A

### RELATED APPLICATIONS

This application claims the benefit of the filing date of provisional application Ser. No. 60/452,814, filed Mar. 10, 2003, the entire disclosure of which is incorporated by reference herein as if fully set forth in its entirety.

### BACKGROUND OF INVENTION

1. Field of the Invention

The present invention relates generally to a note holder, and more particularly to a note holder comprising an extruded plastic blade equipped with clips to grab notice papers.

2. Discussion of the Invention

For many years people have used several apparatus and methods to hold notice papers. People have used all kind of practices such as thumbtacks, tapes, and many others like double stick. A note holder is used to hold a piece of paper such as a note or a business card to notify or remind someone about something. However, the conventional note holder and the use of the currently used methods have the following shortcomings:
1. The conventional note holder can be used to hold small pieces of paper only.
2. The use of thumbtacks can be hazardous and difficult when, for instance, pressing a tack on wood.
3. Conventional note holders and hanging papers from walls and desks give a very poor impression for the indecorous presentation of papers.
4. The use tapes may damage papers. Tape also may stick to the fingers and hands and may be difficult to remove and cause problems with freshly painted walls when removing.
5. Sometimes papers cannot be posted for the lack of tape or thumbtacks.

To overcome the shortcomings, the present invention intends to provide an improved note holder assembly to mitigate the aforementioned problems.

There are certain systems and methods in the prior art designed to hold notes. However, the invention disclosed in this application is patentably distinct and a unique improvement from the note holders of the prior art in several different aspects. Therefore, it can be appreciated that there exists a continuing need for a new and improved note holder to grab notice papers, which overcomes these and other deficiencies in the prior art. In this regard, the present invention substantially fulfills this need. The present invention overcomes the inability of the prior art to provide an extruded plastic blade equipped with clips to grab notice papers that takes advantage of the notice holders developed to date. Various novel note holders have recently been disclosed, yet none provide a more reliable and cost note holder as the extruded plastic blade equipped with clips to grab notice papers of the present invention.

None of the art considered above, taken either simply or in combination teaches the use of an extruded plastic blade equipped with clips to grab notice papers. In light of the foregoing, it will be appreciated that what is needed in the art is a notice holder that incorporates the teachings of the present invention.

### SUMMARY OF THE INVENTION

The object of the present invention is to provide a simple, cost effective, and safe way to post a paper in an office.

A further object of the present invention is to provide an apparatus that helps in the posting of papers in an office that is aesthetically pleasing.

The notice holder of the invention itself, both as to its configuration and its mode of operation will be best understood, and additional objects and advantages thereof will become apparent, by the following detailed description of a preferred embodiment taken in conjunction with the accompanying drawing.

When the word “invention” is used in this specification, the word “invention” includes “inventions”, that is, the plural of “invention”. By stating “invention”, the Applicant does not in any way admit that the present application does not include more the one patentable and non-obviously distinct invention and Applicant maintains that the present application may include more than one patentably and non-obviously distinct invention. The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

FIG. 1 is a perspective view of the front of the notice holder of the invention.

FIG. 2 is a perspective view of the back of the notice holder of the invention.

FIG. 3 is a side view of the notice holder of the invention.

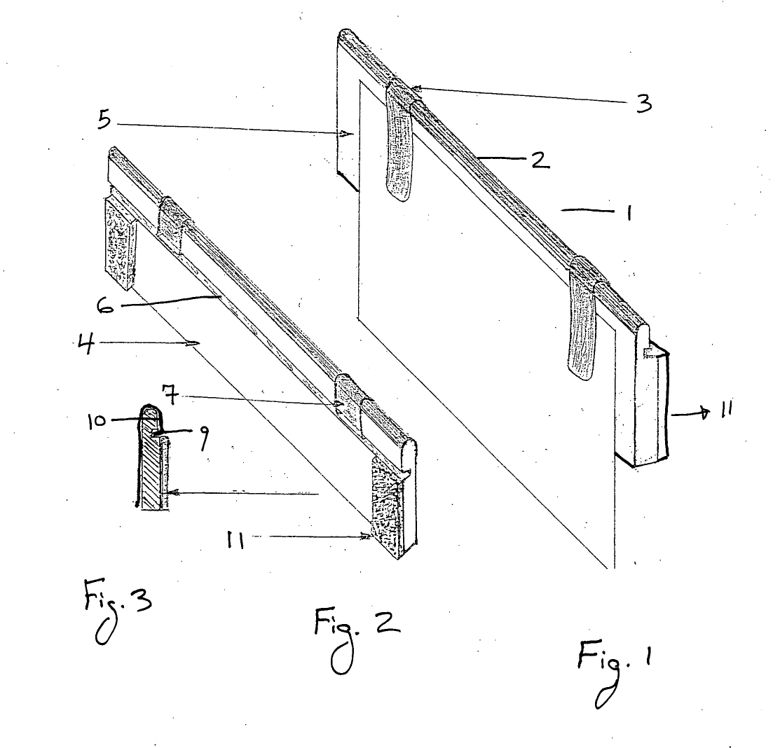

### DESCRIPTION OF THE PREFERRED EMBODIMENT

Turning to the drawings, the notice holder of the present invention 1 comprises a blade 2 made out of a plastic material such as acrylic or any other similar material, and having a top part 3, a back part 4, a front part 5, and an opposite pair of ends. Said blade's top part 3 having a round shape, and said blade being extruded to the following size 1⅜″ wide, 3/16″ thickness; said blade further comprising a channel groove 6 (1/16″×1/16″) and a plurality of clips 7 made according to the profile of the blade. The clips may be slid in the blade by the channel groove.

The top part of the blade is round in shape so as to match the shape of the clip function and a plurality of clips. The profile of the clip is designed to hold a paper.

The channel groove plays a very important part in the efficiency and facility of use of the invention. The length of the blade may fluctuate from approximately 3 to approximately 6 feet.

In the preferred embodiment the clips that sustain the papers are made of stainless steel to assure the durability and to prevent oxidation. For manufacturing the material should be bought in coils having 0.0030 gauge 5/16″ wide.

The clips may be manufactured in a punch press with a good cutting and forming punch press die. The clips have a lip inset 9 in the groove. The back bend 10 prevents the clips from twisting and slides across the grove just by pushing the clip to the desired position.

Both end corners of the clips are round so it does not stock and slide smooth when the clips have to be moved.

This invention consists of a blade made of acrylic or any plastic material in the field of plastic industry that has the qualities required for manufacturing an efficient product.

The channel groove has 3 functions: first it is a practical way to install clips. Second, it provides a way to anchor the clip. Third, it provides a way to select the distance between clips for different sizes of paper.

To post a paper, the user of the note holder will take the paper with his or her finger and insert the paper under the clip through the lip at the top of the paper. To remove the paper, the user just needs to pull the paper down.

To use double stick foam to install the blade the user just needs to remove the cover paper of the double stick foam 11 which may be attached to the back of the blade. The note holder of the invention is very handy, but for a complete installment and secure procedure, the use of screws is recommended.

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

1. A note holder, comprising:
a blade having a top part of round shape, a bottom part, a front part, a back part, a first end and a second end;
a channel groove cut on the back part of the blade extending from the first end of the blade to the second end of the blade;
a plurality of clips, said plurality of clips each having a round top part to match the round top part of the blade so that each of the clips may slide across the top part of the blade, a back part that rests against the back part of the blade, and a hook part disposed so that said clips may be rigidly attached to blade by fixing the hook part to the channel groove, and an arm extending from the top part of the clips wherein said arm exerts pressure on notice papers so as to hold them onto the front part of the blade; and
means to fix the blade to a wall or other place.

2. The note holder of claim 1, wherein said plurality of clips may be disposed along said channel groove so as to adjust the distance amongst the clips and provide for the different sizes of papers or notes.

3. The note holder of claim 2, wherein the plurality of clips are made of stainless steel or another suitable material.

4. The note holder of claim 2, wherein said blade is made of a plastic-like material such as acrylic.

5. The note holder of claim 3, said blade having a thickness of approximately 3/16 inches and a width of approximately 1 and ⅜ inches.

6. The note holder of claim 5 wherein said means to fix the blade to a wall is a plurality of screws.

7. The not holder of claim 5 wherein said means to fix the blade to a wall is double stick foam tape.
